(19) United States
(12) Patent Application Publication
(10) Pub. No.: US 2009/0006327 A1
(43) Pub. Date: Jan. 1, 2009

(54) Intelligent Database Scanning

(75) Inventor: Johan Pamp, Svedala (SE)

Correspondence Address: POTOMAC PATENT GROUP PLLC, P. O. BOX 270, FREDERICKSBURG, VA, 22404, US

(73) Assignee: Telefonaktiebolaget L M Ericsson (publ), Stockholm (SE)

(21) Appl. No.: 11/770,925

(22) Filed: Jun. 29, 2007

(51) Int. Cl. G06F 17/30

(52) U.S. Cl. 707/3; 707/E17.061

(57) ABSTRACT

Locating potential licensees and infringers of a patent or other intellectual property can be facilitated by determining whether someone other than the property owner is trying or has tried to patent the same or related subject matter. For example, if an applicant files a patent application but does not respond to an action or other patentability opinion by a patent office that cites prior art references, then it can be presumed that one or more of the cited references must be of interest for the applicant, and vice versa with respect to the owners of the cited references. References cited and, if desired, whether an applicant has responded to a patent office's patentability opinion can be determined from patent data publicly available in computer databases maintained by many patent offices around the world.

### BACKGROUND

This invention relates to searching computer databases and more particularly to searching computer databases of patent-related information.

Today, the value of licensing patents and detecting patent infringement is continually increasing for technology-oriented companies and other patent owners. It is important for a patent owner to find possible licensees at an early stage in order to receive as much return as possible on the investment in the patent. It is also important to identify at an early stage any possible infringement of the patent, although it can be very difficult and expensive if not impossible to identify infringement.

Patent data, including the text and/or images of patents and communications exchanged by patent applicants and patent offices, resides in many computer databases that are accessible in many ways, e.g., via the Internet. For example, the U.S. Patent and Trademark Office (USPTO) maintains a patent full-text and image database located at http://patft1.uspto.gov/netahtml/PTO/search-adv.htm, a patent application full text and image database located at http://appft1.uspto.gov/netahtml/PTO/search-adv.html, and a patent application information retrieval database located at http://portal.uspto.gov/external/portal/pair, among other accessible databases. For another example, the European Patent Office (EPO) maintains a database of patent data located at http://www.epoline.org/portal/public/registerplus, among other accessible databases. Other national patent offices and international patent organizations also maintain publicly accessible databases of patent data.

These computer databases can be queried for patent data of interest by supplying appropriate sets of text strings and commands to search engines associated with the databases. For example, U.S. Patent Application Publication No. 2002/0147738 by Reader states that it describes an automated search technique for discovering patent-relevant publications on the Internet. A search client resident on a user's computer initiates linked searches for patent language and documents in a manner transparent to the user. The search may be conducted in databases that include summaries or full-text documents.

U.S. Pat. No. 6,879,990 to Boyer et al. describes a system for identifying potential licensees of a source patent portfolio. The source patent portfolio, comprising, for example, all the patents owned by a particular entity, is created, and a set of patents that are related to or associated with the patents in the source patent portfolio is generated based on patent classes and citation information. Unlicensed assignees of patents in the set of related patents are organized according to various criteria, and the organization provides an indication of assignees that may be potential licensees of the patents in the source patent portfolio.

Nevertheless, problems remain in trying to identify patent applications that may be relevant to an intellectual property of interest.

### SUMMARY

In accordance with aspects of this invention, there is provided a method of identifying information that is relevant to an intellectual property. The method includes the steps of scanning a computer database of patent data, wherein the patent data includes information about patent application prosecutions; and as a result of a scan, locating information that an indicator of the intellectual property is cited in a patentability opinion issued in a patent application.

In accordance with further aspects of this invention, there is provided an apparatus for identifying information that is relevant to an intellectual property. The apparatus includes a user computer in electronic communication with a computer database of patent data that includes information about patent application prosecutions. The user computer is configured to query the database and receive query results that include information that an indicator of the intellectual property is cited in a patentability opinion issued in a patent application.

In accordance with further aspects of this invention, there is provided a computer-readable medium encoded with a computer program for identifying information that is relevant to an intellectual property. The computer program when executed causes the computer to perform the steps of scanning a computer database of patent data that includes information about patent application prosecutions; and as a result of a scan, locating information that an indicator of the intellectual property is cited in a patentability opinion issued in a patent application.

### BRIEF DESCRIPTION OF THE DRAWINGS

The various objects, features, and advantages of this invention will be understood by reading this description in conjunction with the drawings, in which:

FIG. 1 is a flow chart of a method of identifying potential licensees and infringers;

FIGS. 2A, 2B are show exemplary patent data located in a computer database; and

FIG. 3 is a block diagram of a computer system.

### DETAILED DESCRIPTION

The inventor has recognized that a search for potential licensees and infringers of a patent can be facilitated by determining whether someone other than the patent owner is trying or has tried to patent the same or related subject matter. If an applicant files a patent application but does not respond to an action or other patentability opinion by a patent office that cites prior art references, then it can be presumed that one or more of the cited references must be of interest for the applicant, and vice versa with respect to the owners of the cited references. Whether an applicant has responded to a patent office's patentability opinion can be determined from patent data publicly available in computer databases maintained by many patent offices as described above.

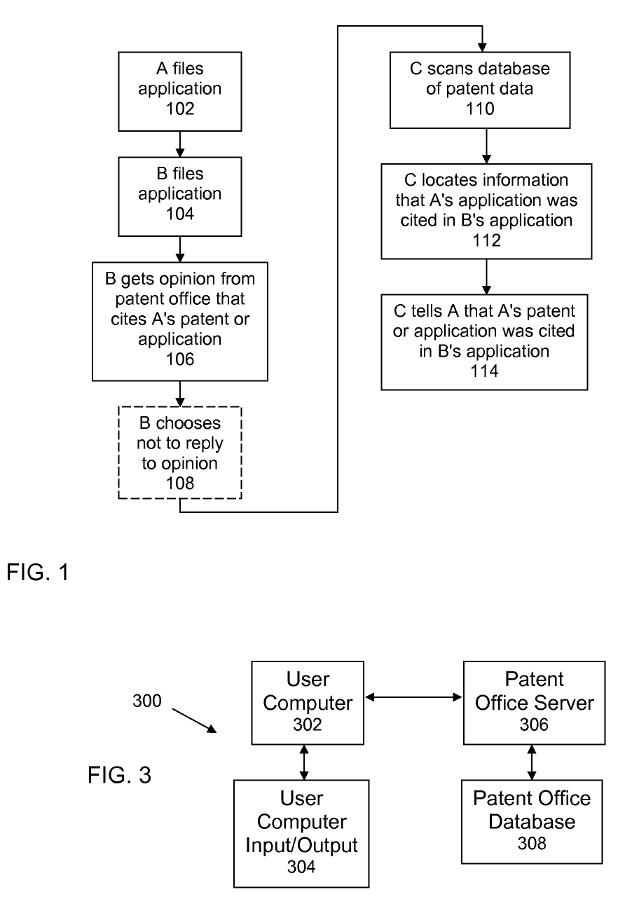

FIG. 1 is a flow chart of a method of identifying information that is relevant to an intellectual property, e.g., the identity of potential licensees and infringers, that assumes three parties, A, B, and C. Party A is the owner of a patent and has an interest in identifying potential licensees and infringers of the patent. Party B is an applicant who has filed a patent application directed to the same or similar subject matter as Party A's patent. In this example, Party B is a potential licensee or infringer of interest to Party A. Party C locates information that Party B could be a licensee of Party A, information that Party C can sell to Party A. It should be understood, however, that Party A and Party C can be the same entity as described further below.

In step 102, Party A files a patent application in a patent office, such as the USPTO or the EPO, or obtains a patent from a patent office. Filing a patent application or obtaining a patent is used in this application as a general signpost indicative of intellectual property that is commonly cited by patent offices. It will be understood that instead of or in addition to a patent application or patent, Party A can be responsible for other information that can be cited by a patent office, such as a magazine article, book, or other printed publication, and that Party A can associate with licensable intellectual property, such as a trade secret or know-how or some other form of intellectual property. As explained below, even if Party A's patent application is not granted, it could be of interest for Party A to know that someone else is interested in the same or similar subject matter.

Party B files a patent application (step 104) that is directed to subject matter that is the same as or similar to the subject matter of Party A's patent or patent application. At least initially after becoming aware of Party B's patent application, Party A can assume that Party B has some kind of filing strategy behind the application, e.g., Party B may be seeking to protect a product.

In due course, Party B gets a patentability opinion from the patent office (step 106), such as an Action by the USPTO, an International Search Report by an International Searching Authority, a Written Opinion by an International Preliminary Examining Authority, etc. The patentability opinion in Party B's application cites Party A's patent, application, or other indicator of intellectual property. It will be understood that it is not always necessary for the patentability opinion to cite Party A's indicator as basis for lack of novelty or non-obviousness (inventive step). It is necessary only that Party A's indicator be cited in the patentability opinion and that the indicator correspond to licensable property.

In step 108, Party B chooses not to respond to the patentability opinion. Party B's reason for not responding is probably unknown to Party A, but is also unimportant. It may be that Party A's patent, application, etc. is so “strong”, from a patentability point of view, that Party B is not able to get a patent, or it could be that Party B is no longer interested in the application. As indicated by the dashed lines in FIG. 1, it is not always necessary that step 108 be carried out.

From time to time, Party C automatically scans public databases (step 110), such as the EPO's Epoline and the USPTO's PAIR, for patent data, including information about application filings and prosecutions. As a result of a scan, Party C locates (step 112) information that a patentability opinion cited Party A's patent, application, etc. in Party B's application. Such information typically includes the opinion itself or at least a list of references cited by the patent office. Party C can also further filter its scans by looking for prosecutions in which Party B chose not to respond to a patentability opinion.

In step 114, Party C informs Party A that Party A's patent, application, etc. was cited in Party B's application, enabling Party A to act appropriately, for example by contacting Party B. If Party B chose not to reply to the patentability opinion, Party C can also supply that information to Party A.

It will be understood that it is not always necessary to carry out all of the steps as depicted in FIG. 1. For example, Party A can scan one or more patent office databases for itself, without incurring the cost of the services of Party C. Either way, Party A obtains information that is relevant to its intellectual property, e.g., information about potential licensees and infringers. As noted above, Party A can assume that Party B may be seeking to protect a product or products that may infringe Party A's intellectual property. Even if Party B does not produce product(s) that infringe Party A's intellectual property, it can be useful for Party A to know that Party B, which may be a patent enforcement company that makes no products, is seeking intellectual property in an area of interest to Party A. An advantage for Party C (and A) is that valuable patent data can be “mined” from patent office computer databases in an easy and affordable way.

Moreover, the method depicted in FIG. 1 can also be modified in various other ways, of course. For example, the method can be focused on identifying how divisional applications are filed. Rather than scanning databases for patent data indicating that Party B chose not to respond to a patentability opinion (step 110), the databases can be scanned for patent data indicating that one or more divisional patent applications have been filed. Such information can be important because such filing just before a patent application is granted can indicate that the applications are important to the owner.

Furthermore, the method depicted in FIG. 1 can also be modified such that Party A is informed of Party B's potential exposure to Party A's patent or application even if Party B chooses to respond to the patentability opinion. Just the citation of Party A's patent or application in a patentability opinion in Party B's application may indicate that Party A has broader coverage than Party B, and thus Party B may infringe Party A's patent.

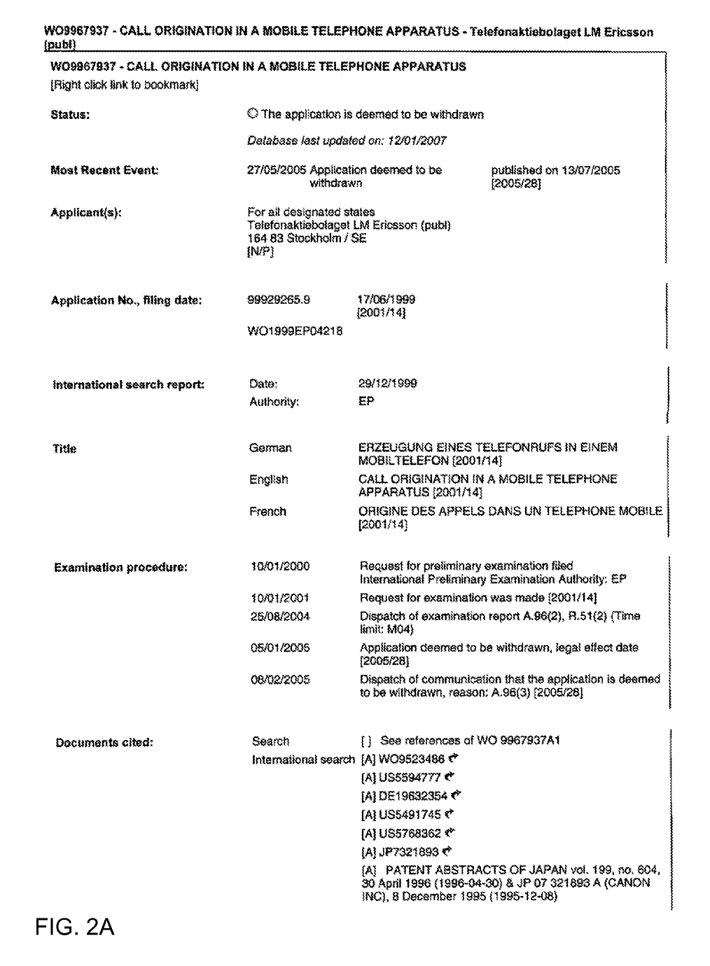

FIGS. 2A, 2B show patent data that was located and retrieved from the Epoline computer database maintained by the EPO. As can be seen in the figures, the patent data relates to International Publication WO9967937, which corresponds to European Patent Application No. 99929265.9 having the English-language title, “Call Origination in a Mobile Telephone Apparatus”. FIG. 2A shows information that the application underwent an examination procedure that produced several patentability opinions, i.e., an examination report on Aug. 25, 2004, and an International Search Report that cited a number of documents, some of which are U.S. patents and the others of which are other kinds of intellectual properties. FIG. 2B shows a “Noting of loss of rights” on Feb. 8, 2005, after the Examination report.

In the methods described above, a database such as Epoline is scanned to locate information indicating situations like that depicted in FIGS. 2A, 2B. Whether a particular intellectual property is cited in a patentability opinion can be determined from the database is several ways. For example, a document number corresponding to an intellectual property can simply be detected in a patentability opinion, such as the list at the bottom of FIG. 2A or the examination report noted in FIGS. 2A and 2B. Further review of the patentability opinion, e.g., determining the frequency or location of citations of a document, can determine whether a cited document was a basis for lack of novelty or non-obviousness (inventive step). Such reviews can be carried out by a suitably configured computers and processors.

The patent data stored in the Epoline database can be downloaded as XML-information to a local memory, and patent data stored in other databases may also be downloaded in a convenient format. It will be understood that the database querying described above may be easier to do on a local copy of the patent data. Database querying is well known in the art.

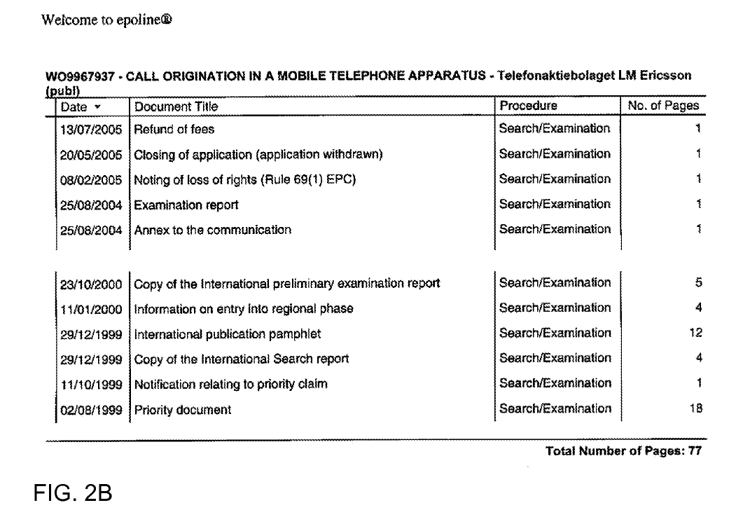

FIG. 3 is a block diagram of a typical apparatus 300 that can be used to carry out the methods described above. A user computer 302 communicates with input/output (I/O) devices 304, such as a keyboard, pointing device, and display, and with a computer server 306 located at a patent office. In a typical arrangement, one or more processors in cooperation with one or more memories in the computer 302 execute suitable program instructions and thereby carry out the methods described above and depicted in FIG. 1. Those of ordinary skill in the art understand how programming languages like C++, Perl, etc. can be used to implement the steps of the methods when the program code is executed by the computer 302.

The server 306 communicates with a database 308 of patent data. It will be appreciated that the communication between the computer 302 and server 306 can be carried out in any suitable way, e.g., by a web browser via the internet. Through such communication, database-search queries can be entered from the user computer 302, run on the database 308, and search results can be returned to the user computer 302 and I/O devices 304. As noted above, patent data can be copied from the database 308 to a local memory accessible to the computer 302 and searched locally rather than remotely searching the database 308.

It is expected that this invention can be implemented in a wide variety of environments. It will be appreciated that procedures described above are carried out repetitively as necessary. To facilitate understanding, many aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

Moreover, the invention described here can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a RAM, a ROM, an erasable programmable read-only memory (EPROM or Flash memory), and an optical fiber.

It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A method of identifying information that is relevant to an intellectual property, comprising the steps of:
scanning a computer database of patent data, wherein the patent data includes information about patent application prosecutions; and
as a result of a scan, locating information that an indicator of the intellectual property is cited in a patentability opinion issued in a patent application.

2. The method of claim 1, further comprising the step of providing located information to an owner of the intellectual property.

3. The method of claim 1, wherein the locating step comprises locating information that no response to the patentability opinion was made.

4. The method of claim 1, wherein the locating step comprises locating information that a divisional patent application that is related to the patent application has been filed.

5. The method of claim 1, wherein the indicator of the intellectual property is at least one of a patent application, a patent, and a printed publication.

6. The method of claim 1, wherein the indicator of the intellectual property is cited in the patentability opinion as a basis for at least one of lack of novelty and obviousness.

7. An apparatus for identifying information that is relevant to an intellectual property, comprising a user computer in electronic communication with a computer database of patent data that includes information about patent application prosecutions, wherein the user computer is configured to query the database and receive query results that include information that an indicator of the intellectual property is cited in a patentability opinion issued in a patent application.

8. The apparatus of claim 7, wherein the electronic communication between the user computer and the computer server is carried out by a web browser via the internet.

9. The apparatus of claim 7, wherein the computer database is located at a patent office.

10. The apparatus of claim 7, wherein the computer database is located at the user computer.

11. A computer-readable medium encoded with a computer program for identifying information that is relevant to an intellectual property, wherein the computer program when executed causes the computer to perform the steps of:
scanning a computer database of patent data, wherein the patent data includes information about patent application prosecutions; and
as a result of a scan, locating information that an indicator of the intellectual property is cited in a patentability opinion issued in a patent application.

12. The medium of claim 11, wherein the computer program causes the computer to perform the further step of providing located information to an owner of the intellectual property.

13. The medium of claim 11, wherein the locating step comprises locating information that no response to the patentability opinion was made.

14. The medium of claim 11, wherein the locating step comprises locating information that a divisional patent application that is related to the patent application has been filed.

15. The medium of claim 11, wherein the indicator of the intellectual property is at least one of a patent application, a patent, and a printed publication.

16. The medium of claim 11, wherein the indicator of the intellectual property is cited in the patentability opinion as a basis for at least one of lack of novelty and obviousness.
